(19) United States
(12) Patent Application Publication
(10) Pub. No.: US 2011/0258561 A1
(43) Pub. Date: Oct. 20, 2011

(54) METHOD, SYSTEM AND PROGRAM PRODUCT FOR PARTICIPATING IN SOCIAL MEDIA SITES ON BEHALF OF ENTITY

(75) Inventors: Ronald P. Ladouceur, Niskayuna, NY (US); Thomas M. Gebauer, Albany, NY (US); Jennifer A. Kobylar, Clifton Park, NY (US); Michael Thomas Smith, Waterford, NY (US)

(73) Assignee: MEDIA LOGIC, USA, LLC, ALBANY, NY (US)

(21) Appl. No.: 12/897,266

(22) Filed: Oct. 4, 2010

Related U.S. Application Data
(60) Provisional application No. 61/324,181, filed on Apr. 14, 2010.

(51) Int. Cl. G06F 3/00; G06F 15/173

(52) U.S. Cl. 715/753; 709/223

(57) ABSTRACT

A software-based dashboard interface on computing units enables user participation in social media sites on a global computer network on behalf of an entity. Contributors collaborate via the dashboards to have electronic conversations regarding existing postings and/or ideas for new postings on social media sites regarding or affecting the entity. One or more of the users develop a proposed posting(s) regarding or affecting the entity and intended for a social media site(s) on the global computer network. A computer-assisted approval process is performed by an Approver for one or more of the proposed posting(s). One or more approved postings are then posted to the social media site(s) via a computing unit(s). A Conversation Manager manages the collaboration, development and posting.

### CROSS-REFERENCE TO RELATED APPLICATIONS

This application claims the benefit of U.S. Provisional Application No. 61/324,181, filed Apr. 14, 2010, which is hereby incorporated herein by reference in its entirety.

### BACKGROUND OF THE INVENTION

1. Technical Field

The present invention generally relates to computer-assisted participation in social media sites on behalf of an entity. More particularly, the present invention relates to computer-assisted collaboration and development of postings to social media sites on a global computer network on behalf of an entity.

2. Background of the Invention

Universal Internet access and mobile communication technologies, combined with website content management systems (CMS), standardized blogging tools, and social media platforms like Twitter, Facebook and Linkedln, combined with inexpensive and easy to use digital asset acquisition technologies like cell phone video cameras and desktop editing tools, have revolutionized marketing. Individuals and organizations can now make their own media and interact and communicate directly with customers, advocates and prospects. In fact, for many organizations, owned media (OM) is more critical to marketing communications than traditional paid or earned media options.

However, though the development of a robust OM platform and the technologies for the acquisition of digital assets now require only modest investment and expertise, the real-time demands of OM content creation and publishing significantly stress traditional content development and authorization processes.

Thus, a need exists for improvements to participation in social media sites on a global computer network on behalf of an entity.

### SUMMARY OF THE INVENTION

Briefly, the present invention satisfies the need for improvements to social media site participation on behalf of an entity by providing a preferably web-based communications application and business process designed to coordinate and assist strategic collaboration, content development, authorization and posting for all OM channels.

While some companies offer component solutions for scanning and monitoring online content (e.g., Techrigy, Radian6) and other companies offer component solutions for composing, scheduling and posting content (e.g., Co-Tweet, HootSuite), the present invention offers both the tools and tested protocols for managing workflow and fully exploiting OM communication opportunities.

Selected points of differentiation:
Unique Manager/Approver workflow protocol
Flexible authorization and approval processes providing clear “paper trail”
Multi-client, multi-initiative and multi-campaign management
Human-filtered conversation monitoring
Team ideation/conversation message board with automated email notification
Private message board for blog and other strategic content development
Team-visible Manager/Approver controlled post approval workspace
Integrated scheduling and archiving
Freedom to post with equal ease to all online platforms

The purpose of the invention is to help organizations centralize, rationalize and collaborate on strategic planning, content development, authorization, and posting within all online owned media channels.

In accordance with the above, it is an object of the present invention to provide an interface for collaboration, development, approval, and posting of content on social media sites on behalf of an entity.

The present invention provides, in a first aspect, a computer-assisted method for participating in at least one social media site on a global computer network on behalf of an entity. The method comprises collaborating by at least two of a plurality of users via a plurality of computing units to have at least one electronic conversation regarding at least one of (a) one or more existing postings regarding or affecting the entity on at least one social media site on a global computer network, and (b) one or more ideas for at least one new posting regarding or affecting the entity on the at least one social media site. The method further comprises developing by at least one of the at least two of the plurality of users via at least one of the plurality of computing units at least one new posting regarding or affecting the entity on one or more social media sites on the global computer network, approving by a predetermined user of the plurality of users via one of the plurality of computing units the at least one new posting, and posting the at least one new posting after the approving on the at least one social media site via one of the plurality of computing units.

The present invention provides, in a second aspect, a computer system for participating in at least one social media site on a global computer network on behalf of an entity, the system comprises a memory, and at least one processor in communication with the memory, the computer system being programmed to perform a method. The method comprises collaborating by at least two of a plurality of users via a plurality of computing units to have at least one electronic conversation regarding at least one of (a) one or more existing postings regarding or affecting the entity on at least one social media site on a global computer network, and (b) one or more ideas for at least one new posting regarding or affecting the entity on the at least one social media site. The system further comprises developing by at least one of the at least two of the plurality of users via at least one of the plurality of computing units at least one new posting regarding or affecting the entity on one or more social media sites on the global computer network, approving by a predetermined user of the plurality of users via one of the plurality of computing units the at least one new posting, and posting the at least one new posting after the approving on the at least one social media site via one of the plurality of computing units.

The present invention provides, in a third aspect, computer program product for participating in at least one social media site on a global computer network on behalf of an entity. The computer program product comprises a physical storage medium readable by a processor and storing instructions for execution by the processor for performing a method. The method comprises collaborating by at least two of a plurality of users via a plurality of computing units to have at least one electronic conversation regarding at least one of (a) one or more existing postings regarding or affecting the entity on at least one social media site on a global computer network, and (b) one or more ideas for at least one new posting regarding or affecting the entity on the at least one social media site. The computer program product further comprises developing by at least one of the at least two of the plurality of users via at least one of the plurality of computing units at least one new posting regarding or affecting the entity on one or more social media sites on the global computer network, approving by a predetermined user of the plurality of users via one of the plurality of computing units the at least one new posting, and posting the at least one new posting after the approving on the at least one social media site via one of the plurality of computing units.

The present invention provides, in a fourth aspect, a method of deploying an application. The deploying comprises providing computer infrastructure operable to perform a computer-assisted method for participating in at least one social media site on a global computer network on behalf of an entity. The computer-assisted method comprises collaborating by at least two of a plurality of users via a plurality of computing units to have at least one electronic conversation regarding at least one of (a) one or more existing postings regarding or affecting the entity on at least one social media site on a global computer network and (b) one or more ideas for at least one new posting regarding or affecting the entity on the at least one social media site. The computer-assisted method further comprises developing by at least one of the at least two of the plurality of users via at least one of the plurality of computing units at least one new posting regarding or affecting the entity on one or more social media sites on the global computer network, approving by a predetermined user of the plurality of users via one of the plurality of computing units the at least one new posting, and posting the at least one new posting after the approving on the at least one social media site via one of the plurality of computing units.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 is an example screen shot for a Contributor showing current conversations and posts being developed.

FIG. 2 is an example screen shot for a Contributor showing approved posts.

FIG. 3 is an example screen shot for a Contributor showing archived postings.

FIG. 4 is an example screen shot for a Conversation Manager showing the current workspace for proposed posts.

FIG. 5 is an example screen shot for a Conversation Manager showing the workspace from FIG. 4, along with a listing of the current conversations.

FIG. 6 is an example screen shot for a Conversation Manager showing approved posts that have not yet been posted, similar to that show in FIG. 2, with the addition of controls over the posts.

FIG. 7 is an example screen shot for a Conversation Manager showing archived posts and their status.

FIG. 8 is an example screen shot for a Conversation Manager showing the creation of a new post when selected from another screen.

FIG. 9 is an example screen shot for an Approver showing the current workspace for proposed posts.

FIG. 10 is an example screen shot for an Approver showing the current workspace, similar to that in FIG. 9, along with a listing of the current conversations.

FIG. 11 is an example screen shot for an Approver showing approved posts, similar to that shown in FIG. 2, but including a feature allowing the Approver to create, approve and post without involvement of others.

FIG. 12 is an example screen shot for an Approver showing archived posts and their status, similar to that shown in FIG. 7 for a Conversation Manager.

FIG. 13 is an example screen shot for an Approver showing the creation of an instant post when selected from another screen.

FIG. 14 is an example screen shot for both a Contributor and an Approver showing the current conversations area.

FIG. 15 is an example screen shot for all roles showing a new conversation creation area arrived at from another screen.

FIG. 16 is an example screen shot for a Conversation Manager showing current conversations with the ability to archive a conversation.

FIG. 17 is an example screen shot for all roles showing archived conversations.

FIG. 18 is a block diagram of one example of a data processing system useful for storing and executing program code to perform the computer-assisted method in accordance with aspects of the present invention.

FIG. 19 is a flow diagram for a computer-assisted method of participating in at least one social media site on a global computer network on behalf of an entity, in accordance with one or more aspects of the present invention.

### DETAILED DESCRIPTION OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

In one example, a computer program product includes, for instance, one or more computer readable storage media to store computer readable program code means or logic thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented at least in part by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the present invention may be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples. Additionally or alternatively, the service provider may receive payment from the sale of advertising content to one or more third parties.

In one aspect of the present invention, an application may be deployed for performing one or more aspects of the present invention. As one example, the deploying of an application comprises providing computer infrastructure operable to perform one or more aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more aspects of the present invention.

Although various embodiments are described above, these are only examples. For example, computing environments of other architectures can incorporate and use one or more aspects of the present invention.

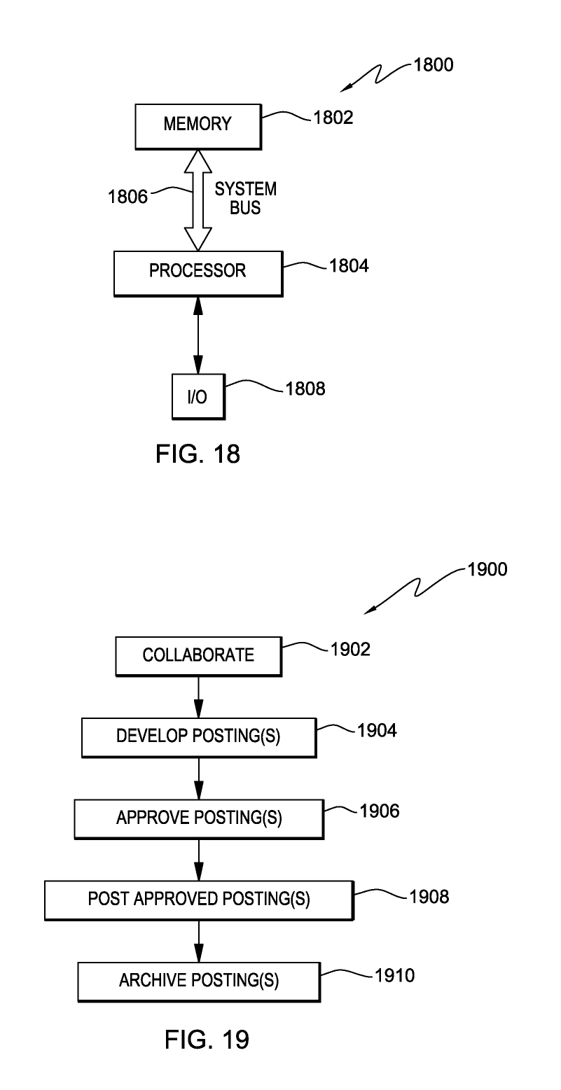

Further, FIG. 18 is a block diagram of one example of a data processing system 1800 suitable for storing and/or executing program code. The system is usable in performing the method of the present invention, and includes at least one processor 1802 coupled directly or indirectly to memory elements 1804 through a system bus 1806. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices 1808 (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

The present invention is an application deployed on one or more computing units (e.g., a web server; preferably web-based) designed to help organizations manage and maximize their OM channels through an online dashboard that facilitates and controls STRATEGIC COLLABORATION, CONTENT DEVELOPMENT, AUTHORIZATION and POSTING.

FIG. 19 is a flow diagram 1900 for one example of a computer-assisted method for participating in at least one social media site on a global computer network on behalf of an entity, in accordance with one or more aspects of the present invention. At least two of the users collaborate 1902 via computing units to have at least one electronic conversation regarding either existing posting(s) regarding or affecting the entity on at least one social media site on a global computer network, or one or more ideas for new posting(s) regarding or affecting the entity on the social media site(s). At least one new posting is developed 1904 by at least one of the collaborating users via the computing unit(s) regarding or affecting the entity on one or more social media sites on the global computer network. A predetermined user approves 1906 the new posting(s) via the computing unit(s). The approved new posting(s) is then actually posted 1908 on the social media site(s) via the computing unit(s). Preferably, the new posting(s) are then archived 1910 after or contemporaneously with being posted.

### Strategic Collaboration

Software-based dashboards, either web-based or local computing-unit based, e.g., local area network or wide-area network based, dedicated to initiatives are distributed to all individuals assigned to contribute, manage or approve items for that initiative on behalf of an entity. The dashboards preferably include some form of security (e.g., user name and password and/or the use of SSL (Secure Sockets Layer)).

Individuals within organizations may be granted access to more than one Dashboard if they are assigned to contribute to more than one initiative. Roles are assigned per Dashboard—Contributor, Conversation Manager, and Approver. Dashboard features and controls vary and automatically adjust depending on assigned role. All team members can initiate conversations and contribute ideas, links and content in the Current Conversations tab.

A service provider deploys the dashboard software, loading and setting it up on one or more servers (e.g., web servers) and possibly client computing units if not web based. The service provider uses the software to help clients to identify relevant and useful social marketing content, debate marketing strategy, compose marketing messages, gain approval to publish, post messages on public social sites and client-owned websites and archive messages. The service provider also preferably provides on-going support for the software.

The service provider provides strategic assistance in determining the number of dashboards that are appropriate for a client installation and provides technical assistance for set up, use and ongoing maintenance of dashboards.

Conversations are the sum of comments and content posted by all Contributors, and may include original ideas, assets (like white papers, videos, news stories, research results, etc.), or the results of new research including results from automated social media scanning technologies.

Generally, during the course of each day, Contributors, on both the client and service provider side, communicate though the dashboards in the form of conversations. The Conversation Manager, preferably a service provider employee, encourages, advances and archives conversations, authors content, posts to-be-approved content to the workspace, schedules and posts content to social platforms and archives posts. Other service provider team members contribute content they believe may be relevant or useful, suggest or comment on marketing strategy and create provisional content as part of their routine service on behalf of the client. An employee of the client typically acts as the Approver.

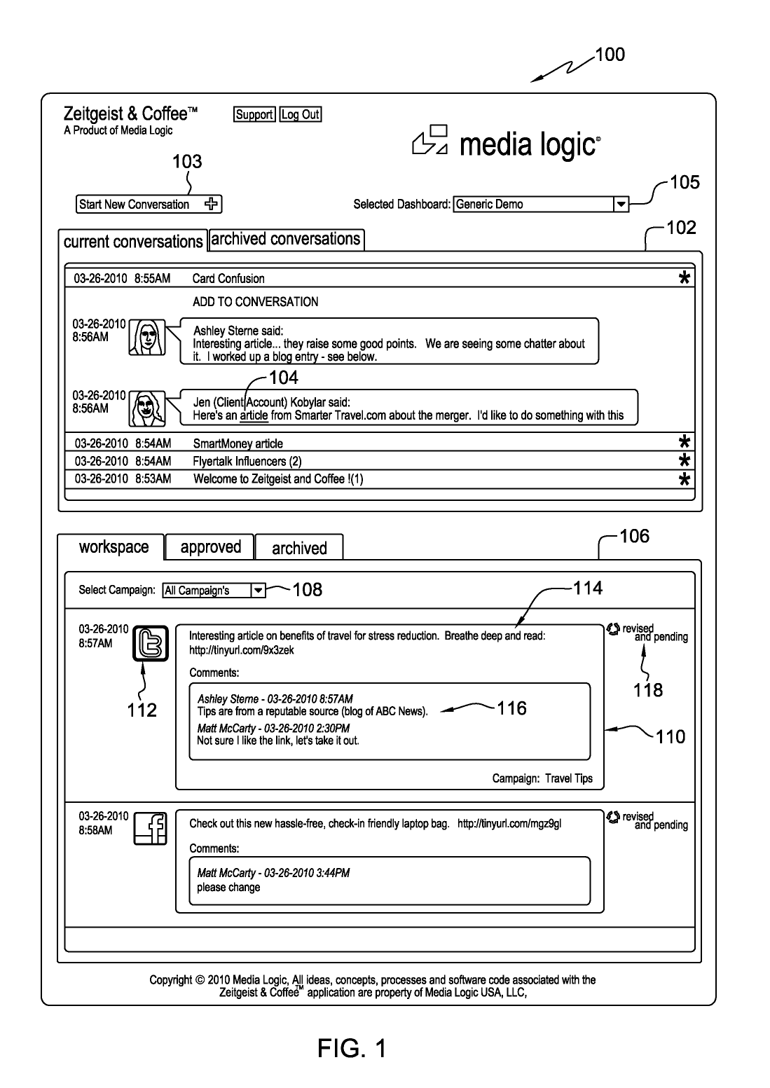

FIG. 1 is an example of a screenshot 100 for a Contributor showing current conversations 102 with all other active Contributors. As shown, the conversations can include links (e.g., link 104) to other documents. Also shown is a button 103 for starting a new conversation, and a drop-down menu 105 for selecting which dashboard to access. Also shown in FIG. 1 is the workspace 106 for developing posts, including the proposed post and comments regarding the proposed post. A drop-down menu 108 can show proposed posts for all campaigns or projects, or for particular ones. The proposed posts include an indication of which social media sites or platform for which they are intended. For example, proposed post 110 includes an icon 112 known to the Contributors as indicating a particular site, along with the proposed post 114 and comments 116 regarding the proposed post. In addition, the proposed posts include a status for the posts (e.g., status 118, “revised and pending”).

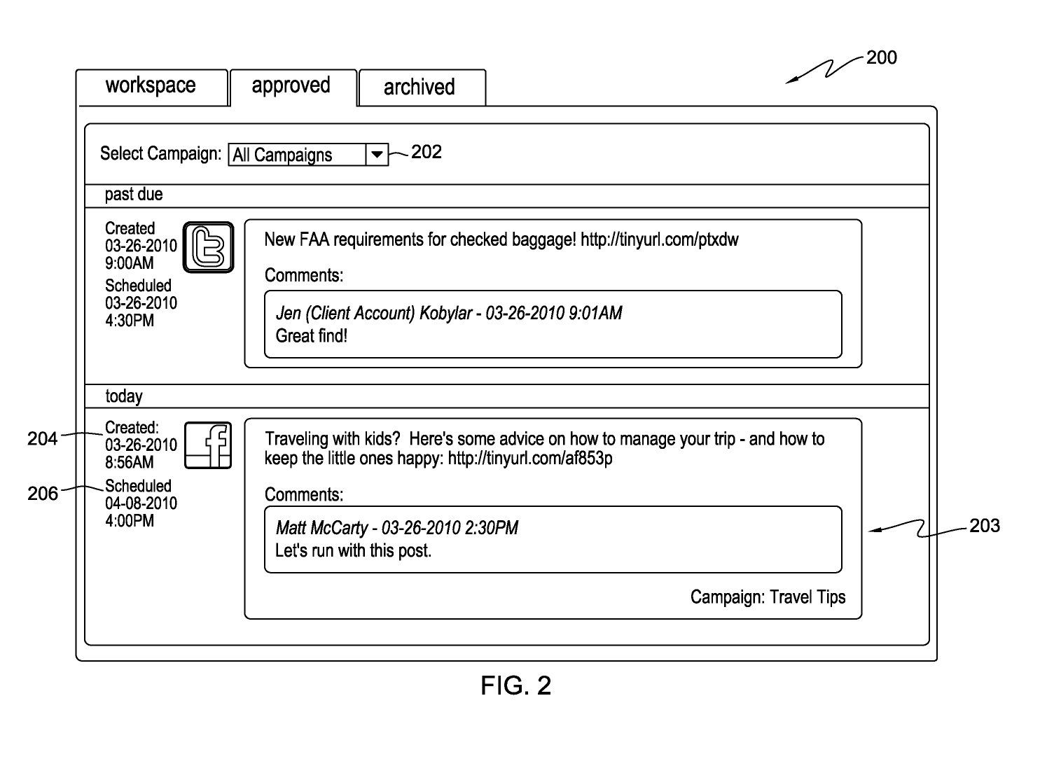

FIG. 2 is an example of a screenshot 200 for a Contributor showing approved posts that have not yet been posted. A drop-down menu 202 can show approved posts for all campaigns or projects, or for particular ones. Also included is a date stamp and a scheduled posting time for each approved post. For example, approved post 203 shows a time stamp 204 and a scheduled posting time 206.

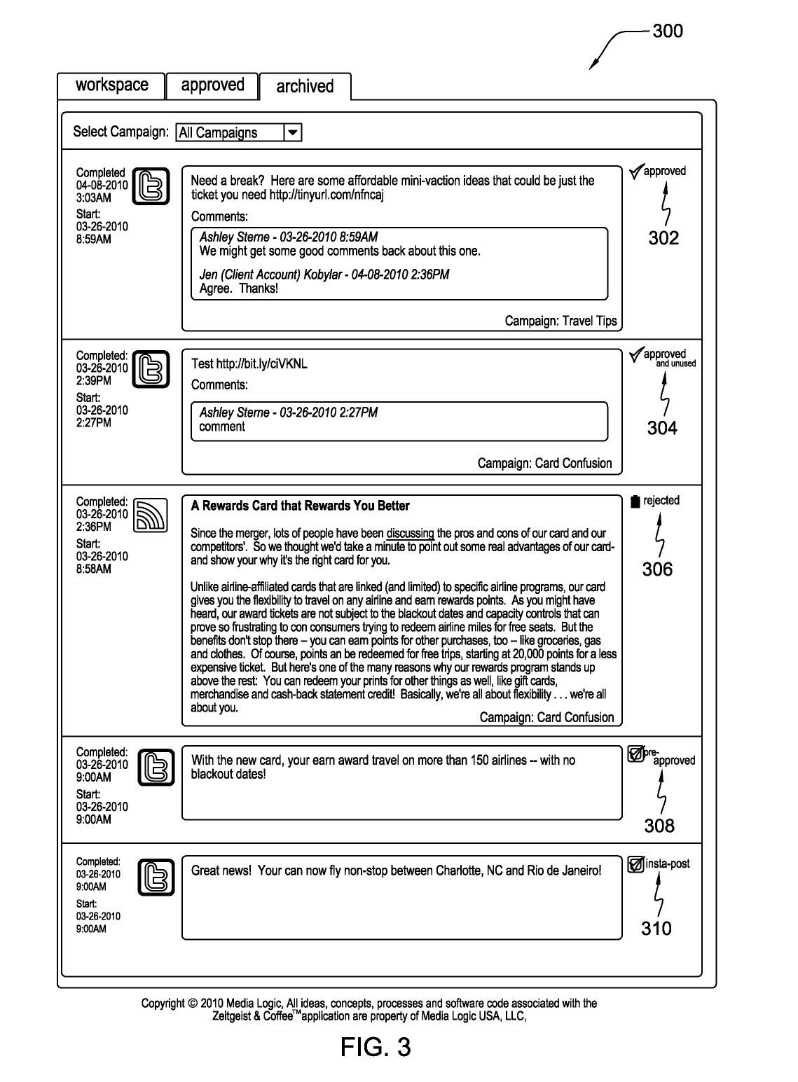

FIG. 3 is an example of a screen shot 300 for a Contributor showing archived posts, along with an indication of the approval status. For example, the approval statuses of the archived items include approved 302, approved ‘and unused 304, rejected 306, pre-approved 308, and “insta-post” 310, which is a post made directly by the Approver.

The Conversation Manager is responsible for hygiene of the Current Conversations tab, moving conversations and comments to the Archived Conversations tab when appropriate.

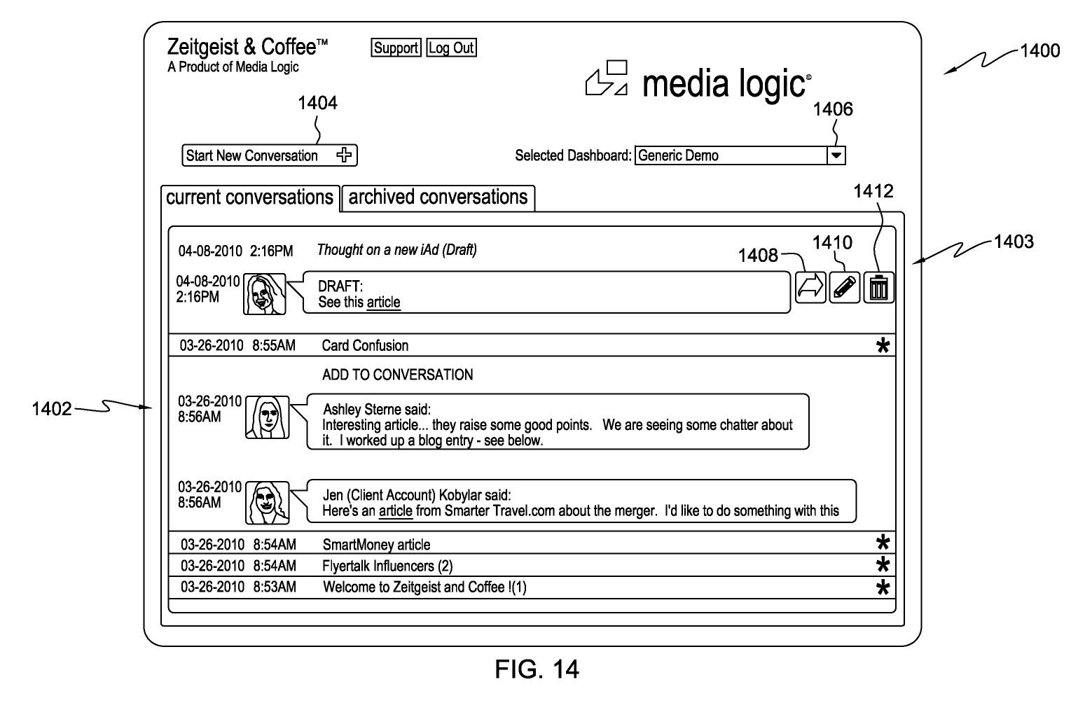

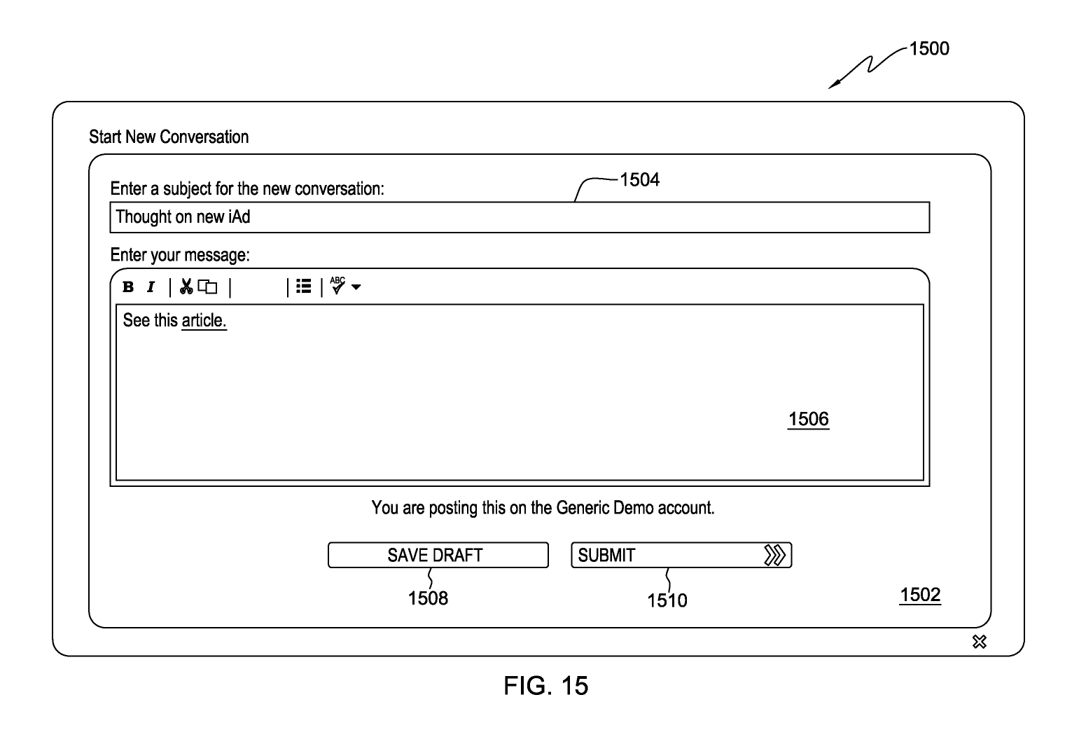

FIG. 14 is an example of a screen shot 1400 for both a Contributor and an Approver showing the current conversations area 1402, including some expanded conversations and earlier unexpanded ones toward the bottom. Also shown is a draft conversation 1403, shown only to the author, a button for starting a new conversation 1404, and a drop-down menu 1406 for selecting from among the possible dashboards. The author can choose to add the draft to the current conversations for all to see (button 1408), edit the draft via button 1410 (and which takes the draft into the screen of FIG. 15), or simply delete the draft via button 1412.

FIG. 15 is an example of a screen shot 1500 for all roles (Contributor, Conversation Manager and Approver) showing a new conversation creation area 1502 that can be arrived at by clicking on the “start new conversation button,” for example, button 1404 in FIG. 14. The area includes an area to enter a subject for the new conversation 1504, and a word processing are 1506 for creating and editing the first message for the new conversation. Also shown are buttons for saving a draft of the message 1508, which shows up for the author similar to entry 1403 in FIG. 14, and submitting the new conversation to the current conversations area 1510 (e.g., area 1402 in FIG. 14).

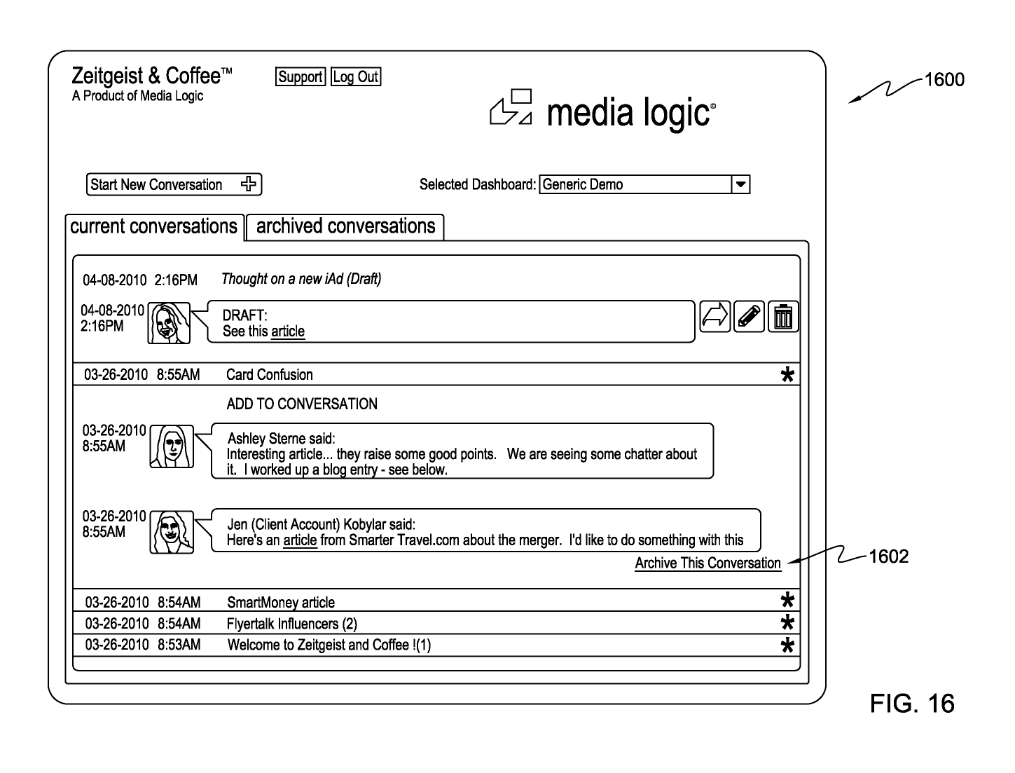

FIG. 16 is an example of a screen shot 1600 for a Conversation Manager showing current conversations with the ability to archive a conversation 1602. Aside from that, screen 1600 is identical to screen 1400 in FIG. 14 for the Approver and Contributor roles.

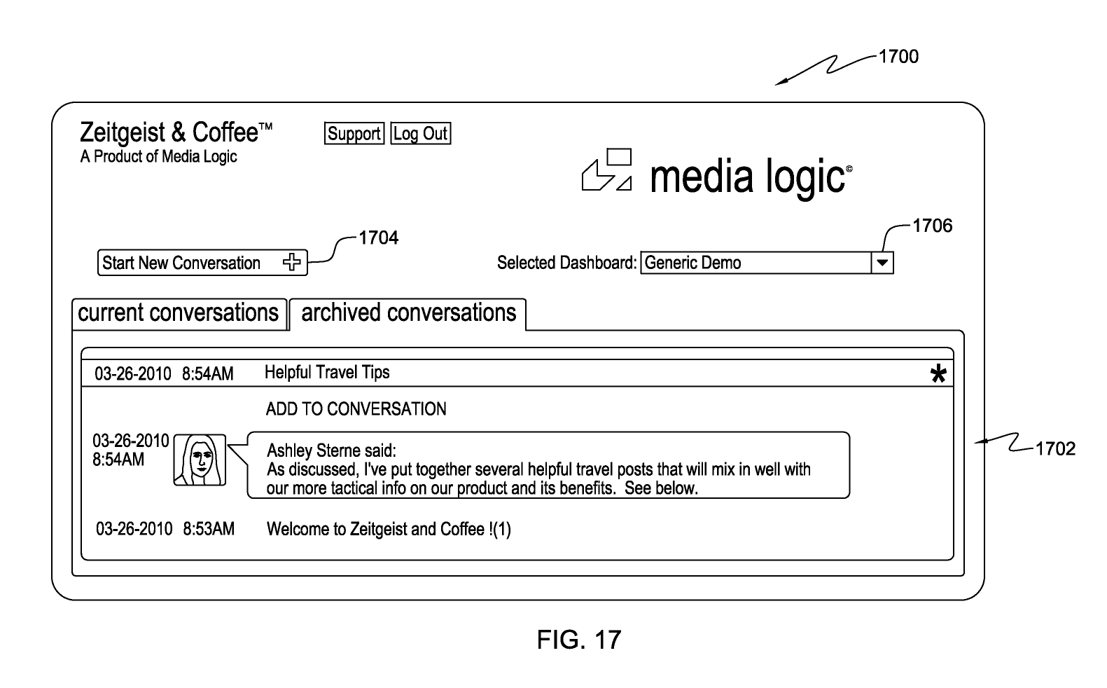

FIG. 17 is an example of a screen shot 1700 for all roles (Contributor, Conversation Manager and Approver) showing archived conversations 1702. Also shown is the button for starting a new conversation 1704 (present in FIG. 16 as well), and a drop-down menu 1706 for selecting from among the possible dashboards.

Email alerts are triggered by every comment made in the Conversations tab. Users can select to receive an email notification for each update, select not to receive updates, or receive a periodic digest of updates.

### Content Development

### Low-Level Content Development

Conversation Manager responsibilities: Working based on Approver command, the Conversation Manager is typically assigned responsibility for constructing and/or refining short posts on social media sites (e.g., Facebook status updates, Twitter posts, etc.). The Conversation Manager makes sure posts conform to the requirements of the intended forum, are properly formatted, meet brand demands for language and technical demands for search optimization.

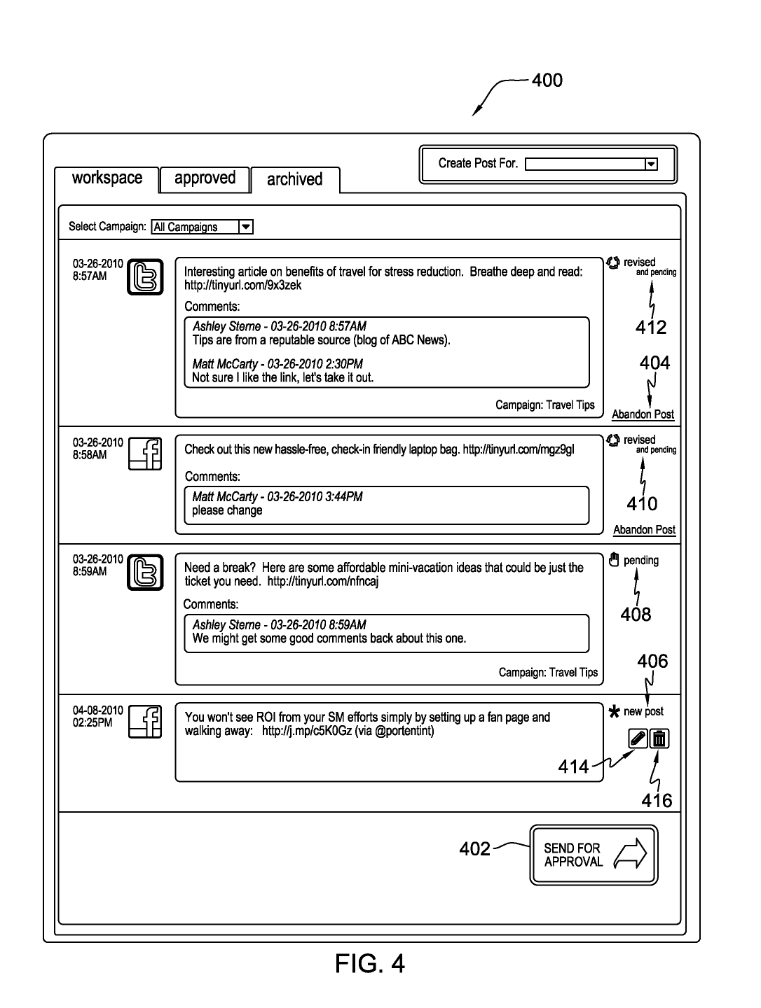

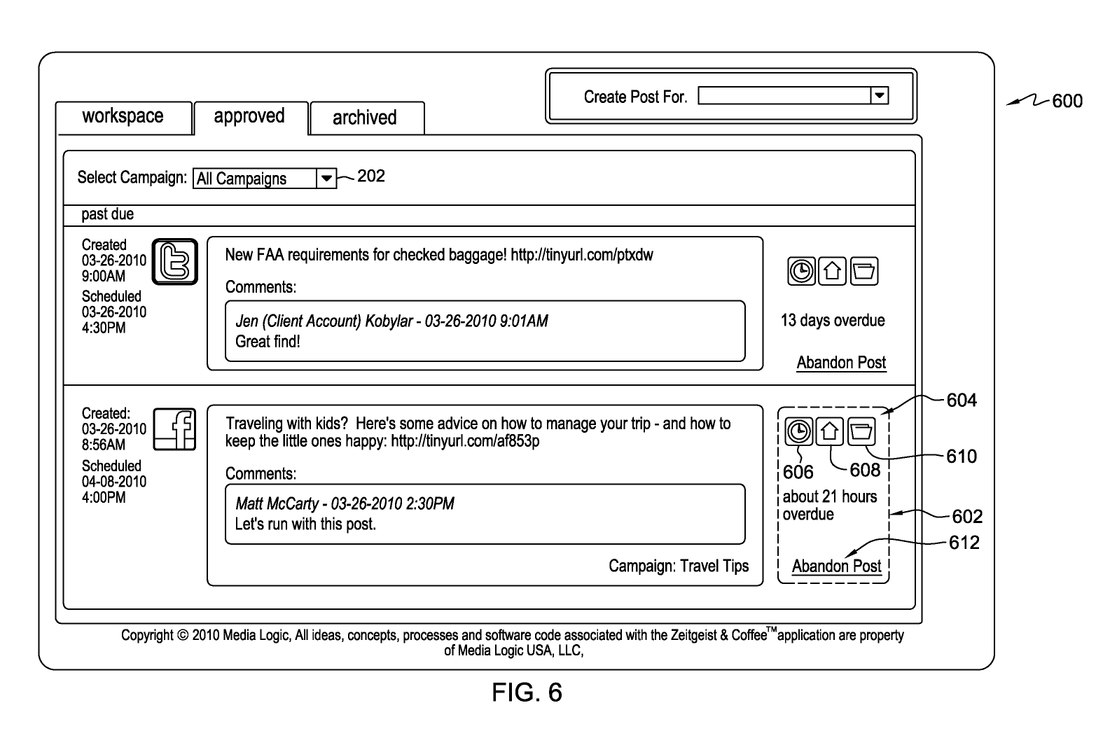

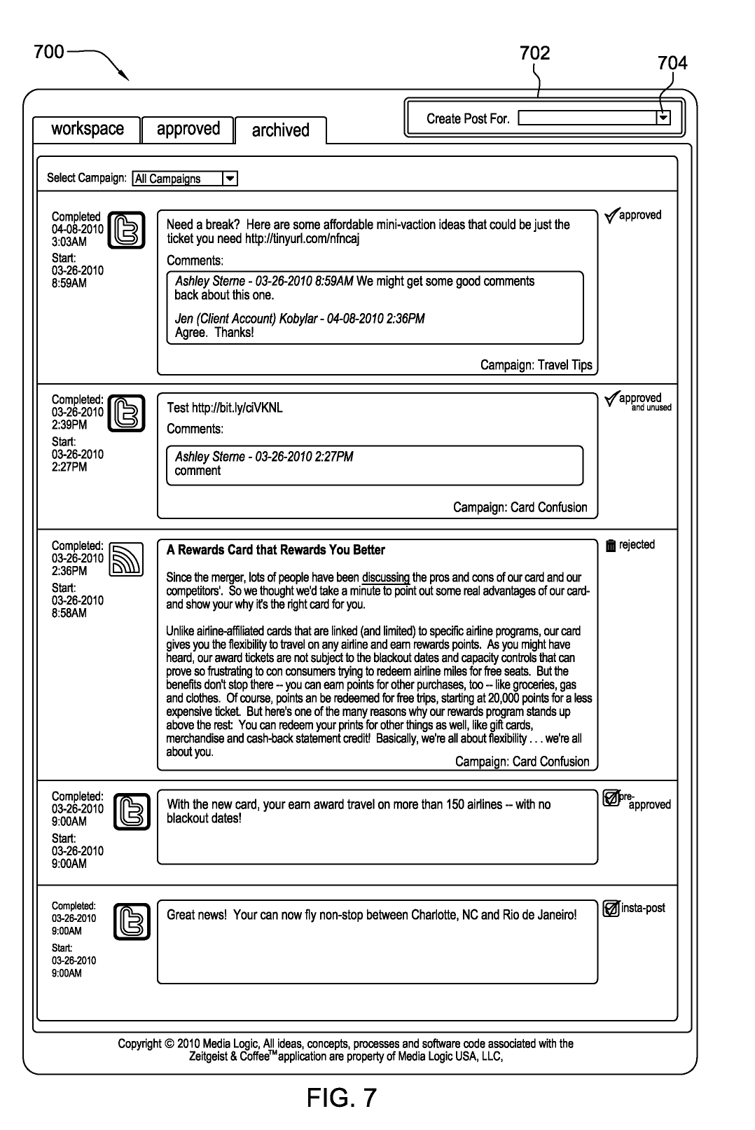

FIG. 4 is an example of a screen shot 400 for a Conversation Manager showing the current workspace for proposed posts. This is much the same as the workspace for a Contributor, with the addition of two items: a button 402 allowing the Conversation Manager to send all new posts to the Approver; and a link 404 to abandon a particular post. Each proposed post includes a status: new post 406; pending 408; and revised and pending 410 and 412. Each new post includes buttons allowing the Conversation Manager to edit 414 or delete 416 the new post. Once new posts have been sent for approval, their status changes to pending. The status of pending means that the Conversation Manager is waiting for the Approver to approve, indicate that revisions are needed or reject the proposed post. If the Approver approves the proposed post, it moves to the screen shown in FIG. 6. If revisions are indicated, the proposed post comes back to the Conversation Manager for editing, revisions are made, and then it is resent for approval. At that point, the status changes to revised and pending. If the proposed post is rejected by the Approver, its status changes to rejected (see, e.g., FIG. 7).

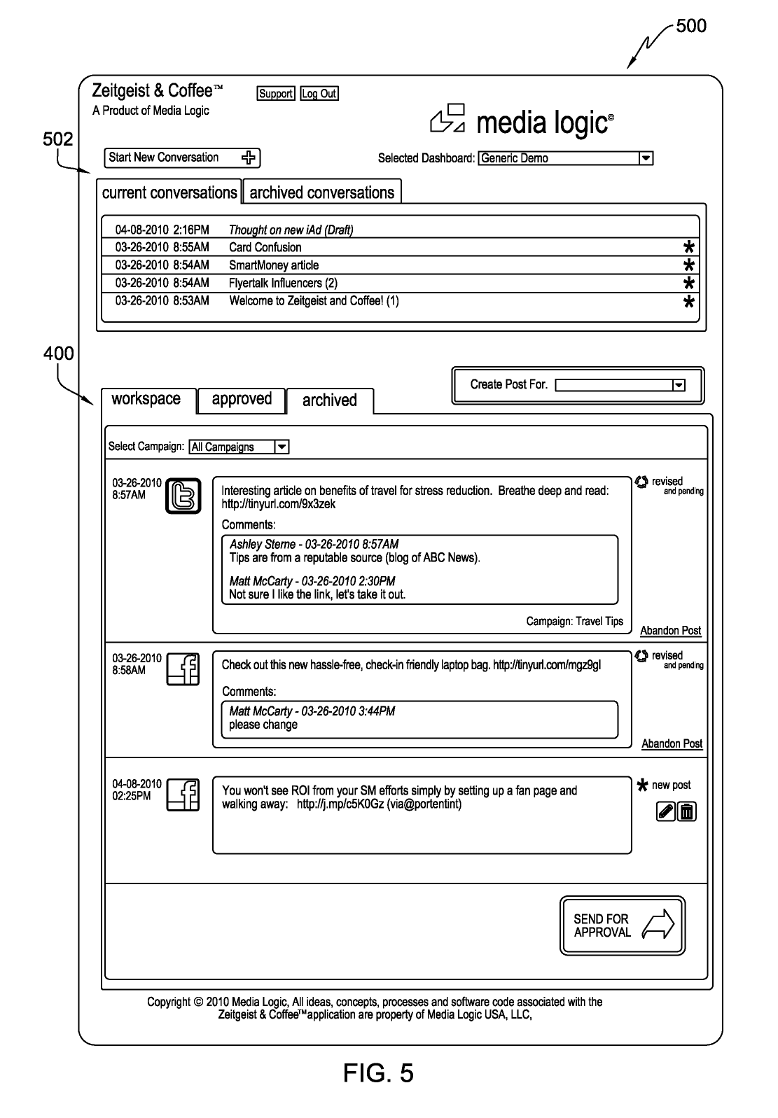

FIG. 5 is an example of a screen shot 500 for a Conversation Manager showing the workspace 400 from FIG. 4, along with a listing 502 of the current conversations, any of which can be expanded, similar to what is shown in FIG. 1 with respect to the Contributor workspace.

FIG. 6 is an example of a screen shot 600 for a Conversation Manager showing approved posts that have not yet been posted, similar to that show in FIG. 2, with the addition of controls over the posts. For example, approved post 602 includes controls 604. The controls allow the Conversation Manager to schedule or unschedule 606 a posting, automatic or manual, post button 608, which is shown grayed out or disabled due to either the particular social media site (i.e., platform) not allowing automated posts, or the account is simply not set up to do so. If automatic posts are allowed and set up, then button 608 would not be grayed out (in this example, it would be blue). Finally, the controls include a button 610 for archiving the posting. If button 608 is not disabled, then button 610 would be disabled, because archiving is automatic. In addition, the Conversation Manager can choose to abandon 612 the post.

FIG. 7 is an example of a screen shot 700 for a Conversation Manager showing archived posts and their status, similar to that shown in FIG. 3 for a Contributor. However, the archived post listing for the Conversation Manager includes a box 702 for creating a post, with a drop-down menu 704 for choosing a platform, similar to that in FIGS. 5 and 6.

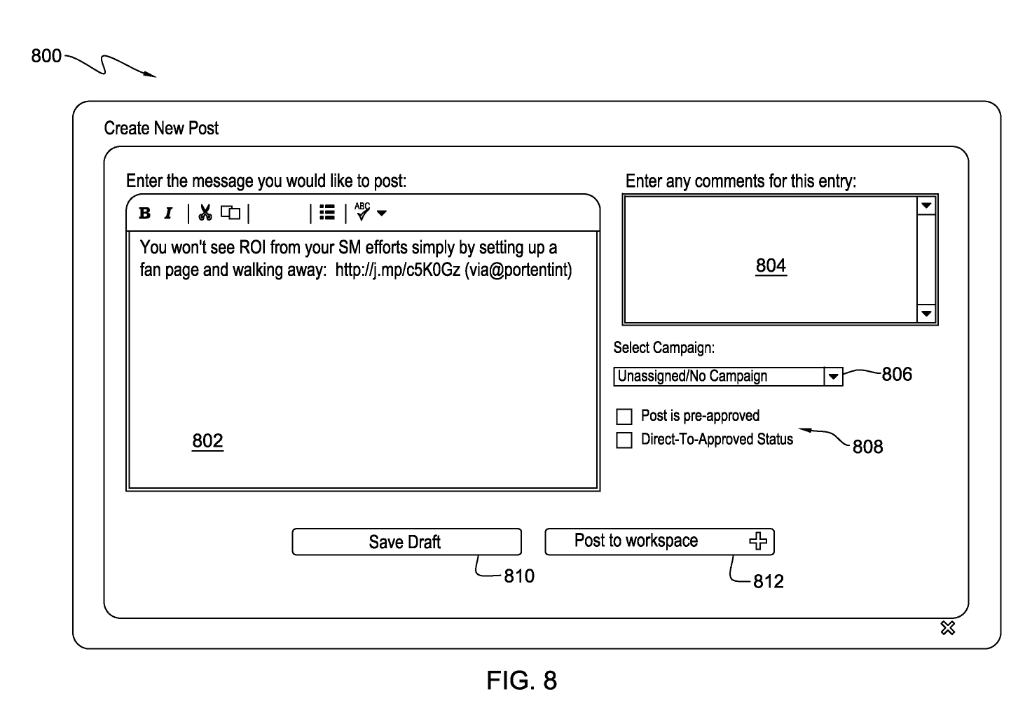

FIG. 8 is an example of a screen shot 800 for a Conversation Manager showing the creation of a new post when selected from another screen. For example, screen 800 can be reached from the post creation area 702 in FIG. 7. The post creation screen includes a word processing area 802 for creating and editing the post, a comments are 804, a drop-down menu 806 for selecting a particular campaign or no campaign (as shown), and check boxes 808 for choosing an approval status, pre-approved or direct-to-approved. The post creation screen also includes buttons for saving a draft of the post 810, and posting to the workspace 812. A draft would then show up in the screen of FIG. 4 and labeled “draft.”

Approver responsibilities: If he or she chooses, an Approver can post without Conversation Manager support through the Insta-Post feature. Insta-Posts are created and posted immediately by an Approver and are preferably automatically archived. The Approver can pre-authorize any team member to post at will. Typically, the Approver pre-authorizes a Contributor to complete a previously approved interaction. This sub-authorization is recorded either in the Conversation Archive or the post Archive, where appropriate.

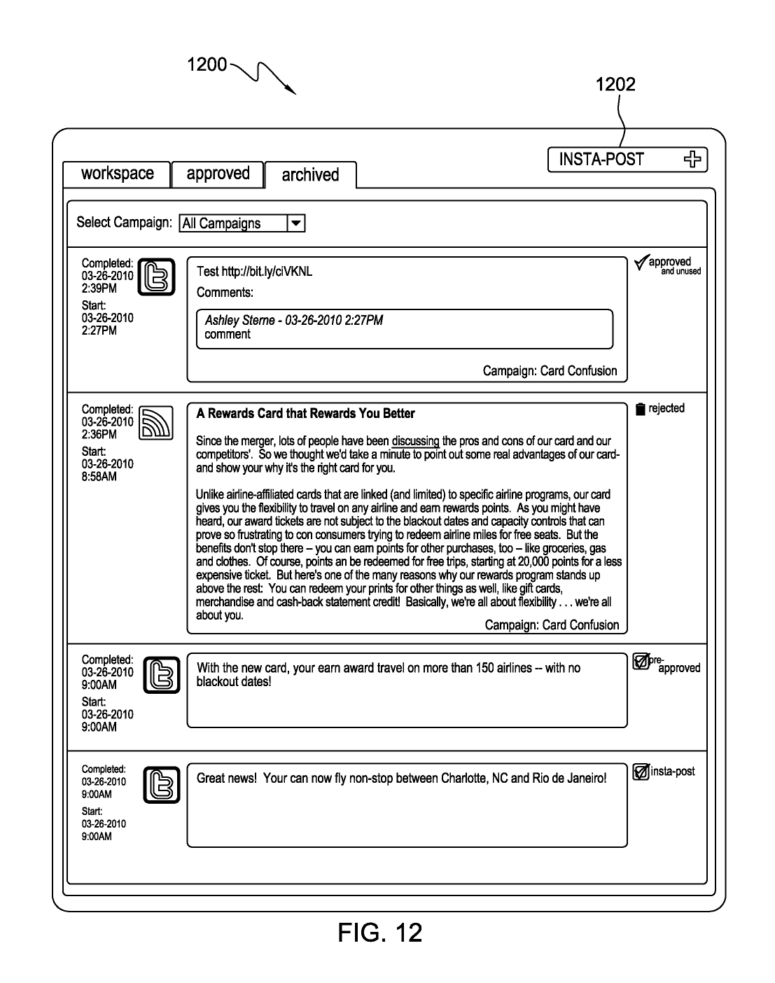

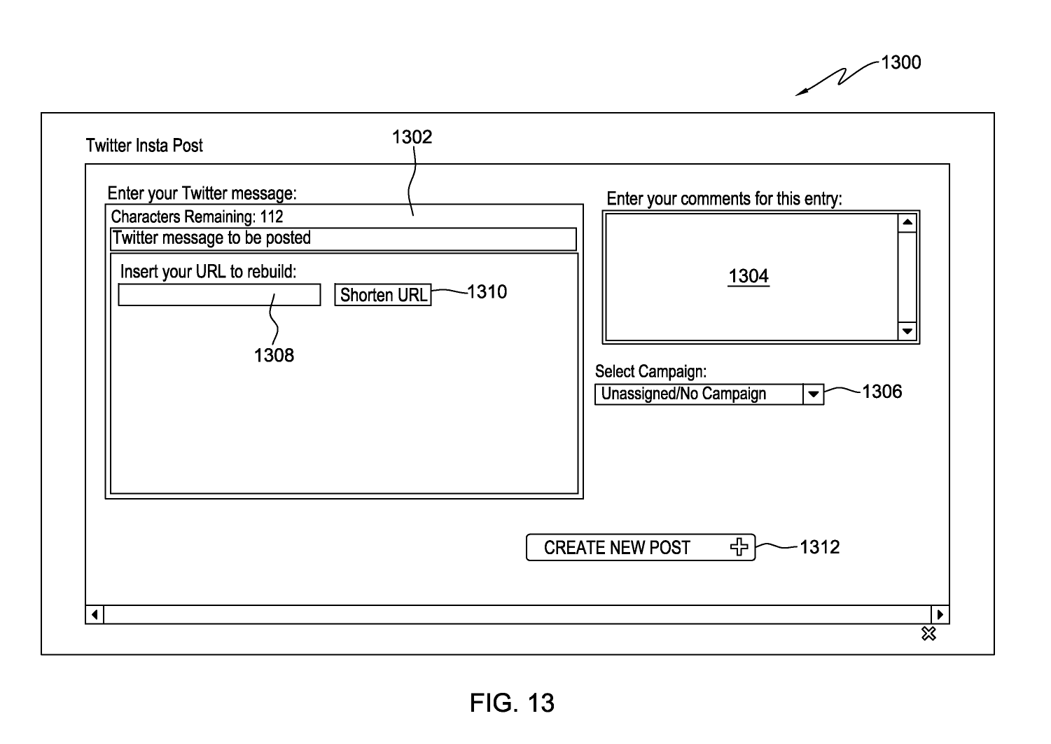

FIG. 13 is an example of a screen shot 1300 for an Approver showing the creation of an instant post (i.e., insta-post) when selected from another screen. For example, screen 1300 can be reached from the insta-post feature 1202 in FIG. 12. The insta-post creation screen includes an area 1302 for creating and editing the post in simple text, an area for comments to accompany the post 1304, a drop-down menu 1306 for selecting a particular campaign or no campaign (as shown), and an area 1308 for inserting a URL for shortening, along with a button 1310 for automatically shortening the URL. The instant post creation screen also includes a button 1312 for automatically posting the new post to the designated platform.

### High-Level Content Development:

Dashboards are envisioned to provide a separate workflow protocol for the development of content the Approver feels should be managed through a private channel. This is typically longer form content, potentially contested content or any content that carries strong “pride of authorship.” Content developed through this channel is visible during creation and revision only to the Approver and the assigned content developer, with select Contributors allowed access at the Approver's discretion. At the discretion of the Approver, this content is moved into the standard Dashboard workflow.

### Authorization

All provisional posts are placed by the Conversation Manager on the Workspace tab. Though visible to the team, the Workspace tab is controlled only by the Conversation Manager and Approver. Using the Workspace tab, the Approver can revise, reject or approve content for publication to one or more OM channels.

The Approver can “pre-authorize” any Contributor to post directly to specific social media channels. “Pre-authorized” posts, which are often merely simple follow-ups to comments or conversations previously authorized, are archived at the discretion of the Contributor, along with the Conversation Manager, who actually does the archiving.

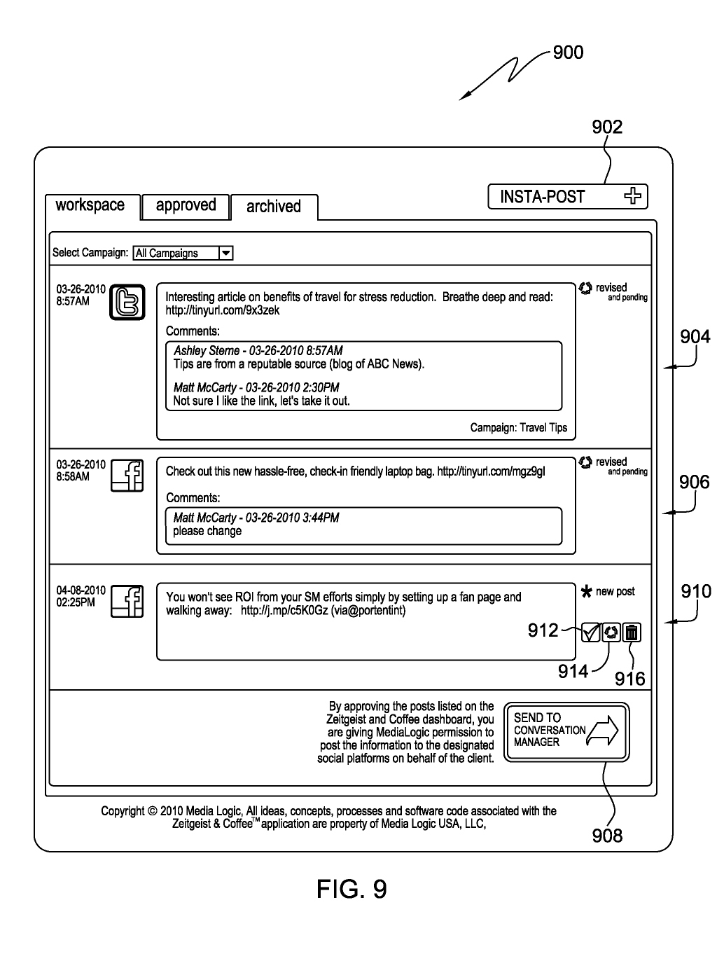

FIG. 9 is an example of a screen shot 900 for an Approver showing the current workspace for proposed posts. This is much the same as the workspace for a Conversation Manager (FIG. 4), with the exception of the insta-post feature 902 versus simply creating a post, and the absence of the abandon-post feature. The first two entries, 904 and 906, were previously sent to the Conversation Manager via the “Send to Conversation Manager” button 908. Proposed posts 910 received by the Approver include status buttons: approve 912; revise 914 and reject 916; any of which result in a word appearing (not shown) indicating the status chosen. The word remains until the “Send to Conversation Manager” button 908 is selected.

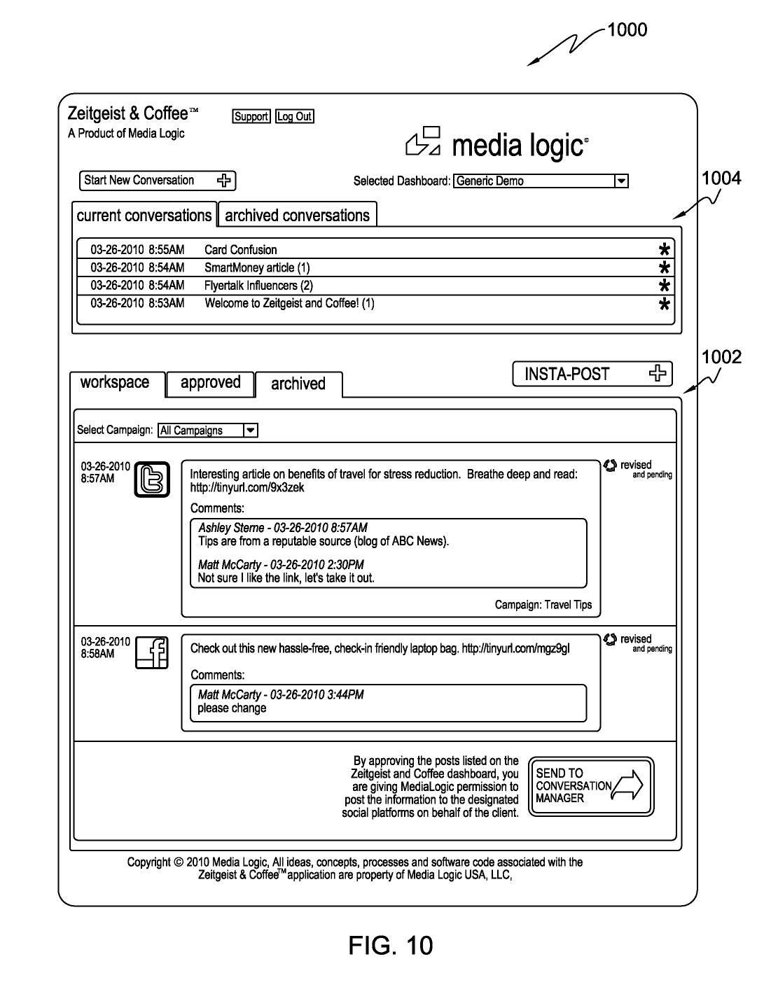

FIG. 10 is an example of a screen shot 1000 for an Approver showing the workspace 1002 similar to that in FIG. 9, along with a listing 1004 of the current conversations, any of which can be expanded, similar to what is shown in FIG. 1 with respect to the Contributor workspace.

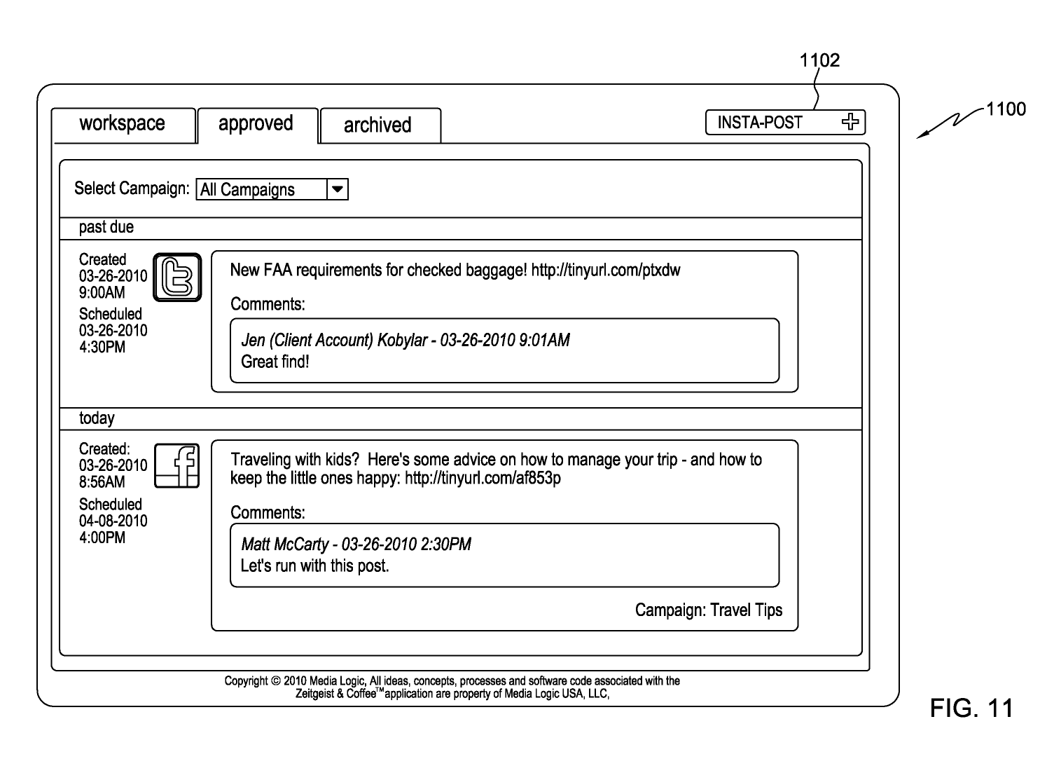

FIG. 11 is an example of a screen shot 1100 for an Approver showing approved posts. Included is the insta-post feature 1102, allowing the Approver to create, approve and post without involvement of others. In all other respects, the approved screen for the Approver is identical to that for Contributors shown in FIG. 2.

FIG. 12 is an example of a screen shot 1200 for an Approver showing archived posts and their status, similar to that shown in FIG. 7 for a Conversation Manager. However, the insta-post feature 1202 replaces the create-a-post feature from FIG. 7.

An offline team can pre-approve responses to common questions and sub-authorize the Conversation Manager to respond immediately at his or her discretion.

### Posting

All posting is managed by the team of Approver and Conversation Manager. For the most part, the Conversation Manager, under the direction and authorization of the Approver, either schedules approved content to be automatically posted and archived, or posts and archives approved content by scheduling for posting manually. Exceptions include any posts or comments “pre-authorized” by the Approver or posts made through the Insta-Post feature.

Approved but not yet posted content appears on the Approved tab, where the Conversation Manager either posts the content at will or schedules and queues content for posting at a later date. See FIG. 6 and the description thereof.

Pre-scripted and approved content (“call center script” content) is posted at the Conversation Manager's discretion based on a global pre-approval.

All content posted by the Conversation Manager, or posted through the Insta-Post feature, is date/time stamped and archived with its authorization status (Approved, Pre-Approved, etc.) attached. Comments or ephemeral commentary (“thanks for the retweet,” “appreciate the comment,” etc.) posted by a delegated-to individual is archived at the discretion of the Contributor, under the control of the Conversation Manager.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiment with various modifications as are suited to the particular use contemplated.

1. A computer-assisted method for participating in at least one social media site on a global computer network on behalf of an entity, the method comprising:
collaborating by at least two of a plurality of users via a plurality of computing units to have at least one electronic conversation regarding at least one of (a) one or more existing postings regarding or affecting the entity on at least one social media site on a global computer network and (b) one or more ideas for at least one new posting regarding or affecting the entity on the at least one social media site;
developing by at least one of the at least two of the plurality of users via at least one of the plurality of computing units at least one new posting regarding or affecting the entity on one or more social media sites on the global computer network;
approving by a predetermined user of the plurality of users via one of the plurality of computing units the at least one new posting; and
posting the at least one new posting after the approving on the at least one social media site via one of the plurality of computing units.

2. The method of claim 1, further comprising archiving the at least one new posting.

3. The method of claim 2, wherein the collaborating and developing comprise providing access to archived postings to the plurality of users.

4. The method of claim 2, wherein the archiving comprises storing information about the at least one new posting.

5. The method of claim 4, wherein the information comprises at least one of a date stamp, a time stamp, a platform for the posting and a posting authorization status.

6. The method of claim 1, wherein each of the plurality of users has at least one predetermined role, wherein the at least one predetermined role comprises at least one of a contributor, a conversation manager, and an approver, wherein a contributor contributes to one or more new conversations, wherein a conversation manager manages the collaborating, developing and posting, and wherein an approver manages the approving.

7. The method of claim 6, wherein the collaborating comprises private collaboration between a contributor and an approver, and wherein the developing comprises development of at least one new private posting by the contributor.

8. The method of claim 7, wherein the approver has discretion to allow one or more other contributors access to the at least one new private posting.

9. The method of claim 7, wherein the approver has discretion to move the development of the at least one new private posting from private to standard collaboration among all contributors.

10. The method of claim 6, wherein individual contributors can be added, terminated or reinstated.

11. The method of claim 6, wherein the approver has discretion to develop, approve and post a posting without involvement of the conversation manager.

12. The method of claim 6, wherein the conversation manager is also a contributor.

13. The method of claim 6, wherein the conversation manager reviews and writes or revises proposed posts against a plurality of criteria.

14. The method of claim 6, wherein the conversation manager determines whether and when to archive conversation entries.

15. The method of claim 6, wherein the approving comprises the approver and the conversation manager having a conversation regarding the at least one new posting between.

16. The method of claim 15, wherein the conversation between the approver and the conversation manager and the at least one new posting are visible to all contributors but can only be contributed to by the conversation manager and the approver.

17. The method of claim 6, wherein the authorizing comprises one of revising, rejecting and approving the at least one new posting.

18. The method of claim 6, wherein the approver has discretion to delegate posting authority to a contributor for pre-approved or minor commentary.

19. The method of claim 6, wherein the conversation manager has discretion to immediately post pre-approved responses to common questions.

20. The method of claim 6, wherein the collaborating, developing, authorizing and posting are performed via a software-based dashboard interface.

21. The method of claim 20, wherein the interface has different functionality for each of the at least one predetermined role.

22. The method of claim 21, wherein a separate interface is provided for each project.

23. The method of claim 20, wherein the interface includes security.

24. The method of claim 20, wherein the interface can be used for at least two currently active projects.

25. The method of claim 1, wherein at least some of the plurality of users receive notification of new conversation entries.

26. The method of claim 25, wherein the notification comprises an email or other electronic communication.

27. The method of claim 26, wherein the email or other electronic communication comprises a periodic digest of new conversation entries.

28. The method of claim 1, wherein the posting comprises at least one of scheduling an automated posting and scheduling a manual posting.

29. The method of claim 1, wherein the collaborating, developing, authorizing and posting are performed via a software-based dashboard interface.

30. The method of claim 29, wherein the interface has different functionality for each of the at least one predetermined role.

31. The method of claim 29, wherein a separate interface is provided for each project.

32. The method of claim 29, wherein the interface includes security.

33. The method of claim 29, wherein the interface can be used for at least two currently active projects.

34. The method of claim 1, wherein the collaborating comprises monitoring posts on the at least one social media site.

35. A computer system for participating in at least one social media site on a global computer network on behalf of an entity, the system comprising:
a memory; and
at least one processor in communication with the memory, wherein the computer system is programmed to perform a method, the method comprising:
collaborating by at least two of a plurality of users via a plurality of computing units to have at least one electronic conversation regarding at least one of (a) one or more existing postings regarding or affecting the entity on at least one social media site on a global computer network and (b) one or more ideas for at least one new posting regarding or affecting the entity on the at least one social media site;
developing by at least one of the at least two of the plurality of users via at least one of the plurality of computing units at least one new posting regarding or affecting the entity on one or more social media sites on the global computer network;
approving by a predetermined user of the plurality of users via one of the plurality of computing units the at least one new posting; and
posting the at least one new posting after the approving on the at least one social media site via one of the plurality of computing units.

36. The system of claim 35, further programmed for archiving the at least one new posting.

37. The system of claim 36, wherein the collaborating and developing comprise providing access to archived postings to the plurality of users.

38. The system of claim 36, wherein the archiving comprises storing information about the at least one new posting.

39. The system of claim 38, wherein the information comprises at least one of a date stamp, a time stamp, a platform for the posting and a posting authorization status.

40. The system of claim 35, wherein each of the plurality of users has at least one predetermined role, wherein the at least one predetermined role comprises at least one of a contributor, a conversation manager, and an approver, wherein a contributor contributes to one or more new conversations, wherein a conversation manager manages the collaborating, developing and posting, and wherein an approver manages the approving.

41. The system of claim 40, wherein the collaborating comprises private collaboration between a contributor and an approver, and wherein the developing comprises development of at least one new private posting by the contributor.

42. The system of claim 41, wherein the approver has discretion to allow one or more other contributors access to the at least one new private posting.

43. The system of claim 41, wherein the approver has discretion to move the development of the at least one new private posting from private to standard collaboration among all contributors.

44. The system of claim 40, wherein individual contributors can be added, terminated or reinstated.

45. The system of claim 40, wherein the approver has discretion to develop, approve and post a posting without involvement of the conversation manager.

46. The system of claim 40, wherein the conversation manager is also a contributor.

47. The system of claim 40, wherein the conversation manager reviews and writes or revises proposed posts against a plurality of criteria.

48. The system of claim 40, wherein the conversation manager determines whether and when to archive conversation entries.

49. The system of claim 40, wherein the approving comprises the approver and the conversation manager having a conversation regarding the at least one new posting between.

50. The system of claim 49, wherein the conversation between the approver and the conversation manager and the at least one new posting are visible to all contributors but can only be contributed to by the conversation manager and the approver.

51. The system of claim 40, wherein the authorizing comprises one of revising, rejecting and approving the at least one new posting.

52. The system of claim 40, wherein the approver has discretion to delegate posting authority to a contributor for pre-approved or minor commentary.

53. The system of claim 40, wherein the conversation manager has discretion to immediately post pre-approved responses to common questions.

54. The system of claim 40, wherein the collaborating, developing, authorizing and posting are performed via a software-based dashboard interface.

55. The system of claim 54, wherein the interface has different functionality for each of the at least one predetermined role.

56. The system of claim 55, wherein a separate interface is provided for each project.

57. The system of claim 54, wherein the interface includes security.

58. The system of claim 54, wherein the interface can be used for at least two currently active projects.

59. The system of claim 40, wherein at least some of the plurality of users receive notification of new conversation entries.

60. The system of claim 59, wherein the notification comprises an email or other electronic communication.

61. The system of claim 60, wherein the email or other electronic communication comprises a periodic digest of new conversation entries.

62. The system of claim 35, wherein the posting comprises at least one of scheduling an automated posting and scheduling a manual posting.

63. The system of claim 35, wherein the collaborating, developing, authorizing and posting are performed via a software-based dashboard interface.

64. The system of claim 63, wherein the interface has different functionality for each of the at least one predetermined role.

65. The system of claim 63, wherein a separate interface is provided for each project.

66. The system of claim 63, wherein the interface includes security.

67. The system of claim 63, wherein the interface can be used for at least two currently active projects.

68. The system of claim 35, wherein the collaborating comprises monitoring posts on the at least one social media site.

69. A computer program product for participating in at least one social media site on a global computer network on behalf of an entity, the computer program product comprising:
a physical storage medium readable by a processor and storing instructions for execution by the processor for performing a method, the method comprising:
collaborating by at least two of a plurality of users via a plurality of computing units to have at least one electronic conversation regarding at least one of (a) one or more existing postings regarding or affecting the entity on at least one social media site on a global computer network and (b) one or more ideas for at least one new posting regarding or affecting the entity on the at least one social media site;
developing by at least one of the at least two of the plurality of users via at least one of the plurality of computing units at least one new posting regarding or affecting the entity on one or more social media sites on the global computer network;
approving by a predetermined user of the plurality of users via one of the plurality of computing units the at least one new posting; and
posting the at least one new posting after the approving on the at least one social media site via one of the plurality of computing units.

70. The program product of claim 69, further comprising archiving the at least one new posting.

71. The program product of claim 69, wherein the collaborating and developing comprise providing access to archived postings to the plurality of users.

72. The program product of claim 69, wherein the archiving comprises storing information about the at least one new posting.

73. The program product of claim 72, wherein the information comprises at least one of a date stamp, a time stamp, a platform for the posting and a posting authorization status.

74. The program product of claim 69, wherein each of the plurality of users has at least one predetermined role, wherein the at least one predetermined role comprises at least one of a contributor, a conversation manager, and an approver, wherein a contributor contributes to one or more new conversations, wherein a conversation manager manages the collaborating, developing and posting, and wherein an approver manages the approving.

75. The program product of claim 74, wherein the collaborating comprises private collaboration between a contributor and an approver, and wherein the developing comprises development of at least one new private posting by the contributor.

76. The program product of claim 74, wherein the approver has discretion to allow one or more other contributors access to the at least one new private posting.

77. The program product of claim 75, wherein the approver has discretion to move the development of the at least one new private posting from private to standard collaboration among all contributors.

78. The program product of claim 74, wherein individual contributors can be added, terminated or reinstated.

79. The program product of claim 74, wherein the approver has discretion to develop, approve and post a posting without involvement of the conversation manager.

80. The program product of claim 74, wherein the conversation manager is also a contributor.

81. The program product of claim 74, wherein the conversation manager reviews and writes or revises proposed posts against a plurality of criteria.

82. The program product of claim 74, wherein the conversation manager determines whether and when to archive conversation entries.

83. The program product of claim 74, wherein the approving comprises the approver and the conversation manager having a conversation regarding the at least one new posting between.

84. The program product of claim 83, wherein the conversation between the approver and the conversation manager and the at least one new posting are visible to all contributors but can only be contributed to by the conversation manager and the approver.

85. The program product of claim 74, wherein the authorizing comprises one of revising, rejecting and approving the at least one new posting.

86. The program product of claim 74, wherein the approver has discretion to delegate posting authority to a contributor for pre-approved or minor commentary.

87. The program product of claim 74, wherein the conversation manager has discretion to immediately post pre-approved responses to common questions.

88. The program product of claim 74, wherein the collaborating, developing, authorizing and posting are performed via a software-based dashboard interface.

89. The program product of claim 88, wherein the interface has different functionality for each of the at least one predetermined role.

90. The program product of claim 89, wherein a separate interface is provided for each project.

91. The program product of claim 88, wherein the interface includes security.

92. The program product of claim 88, wherein the interface can be used for at least two currently active projects.

93. The program product of claim 69, wherein at least some of the plurality of users receive notification of new conversation entries.

94. The program product of claim 93, wherein the notification comprises an email or other electronic communication.

95. The program product of claim 94, wherein the email or other electronic communication comprises a periodic digest of new conversation entries.

96. The program product of claim 69, wherein the posting comprises at least one of scheduling an automated posting and scheduling a manual posting.

97. The program product of claim 69, wherein the collaborating, developing, authorizing and posting are performed via a software-based dashboard interface.

98. The program product of claim 97, wherein the interface has different functionality for each of the at least one predetermined role.

99. The program product of claim 97, wherein a separate interface is provided for each project.

100. The program product of claim 97, wherein the interface includes security.

101. The program product of claim 97, wherein the interface can be used for at least two currently active projects.

102. The program produce of claim 69, wherein the collaborating comprises monitoring posts on the at least one social media site.

103. A method of deploying an application, the deploying comprising providing computer infrastructure operable to perform a computer-assisted method for participating in at least one social media site on a global computer network on behalf of an entity, the computer-assisted method comprising:
collaborating by at least two of a plurality of users via a plurality of computing units to have at least one electronic conversation regarding at least one of (a) one or more existing postings regarding or affecting the entity on at least one social media site on a global computer network and (b) one or more ideas for at least one new posting regarding or affecting the entity on the at least one social media site;
developing by at least one of the at least two of the plurality of users via at least one of the plurality of computing units at least one new posting regarding or affecting the entity on one or more social media sites on the global computer network;
approving by a predetermined user of the plurality of users via one of the plurality of computing units the at least one new posting; and
posting the at least one new posting after the approving on the at least one social media site via one of the plurality of computing units.

104. The method of claim 103, wherein the deploying comprises integrating computer readable code into at least one computer system, wherein the code in combination with the at least one computer system is capable of performing the computer-assisted method.

105. The method of claim 104, the deploying further comprising determining a number of software-based dashboards to deploy and corresponding roles and functionality therefore prior to the integrating.
